(19) United States
(12) Patent Application Publication
(10) Pub. No.: US 2008/0167151 A1
(43) Pub. Date: Jul. 10, 2008

(54) Link plate for silent chain

(75) Inventors: Yoshinori Yonehara, Osaka (JP); Masatoshi Chadou, Osaka (JP)

Correspondence Address: HOWSON AND HOWSON, SUITE 210, 501 OFFICE CENTER DRIVE, FT WASHINGTON, PA, 19034, US

(73) Assignee: Tsubakimoto Chain Co., Osaka (JP)

(21) Appl. No.: 11/998,545

(22) Filed: Nov. 30, 2007

(30) Foreign Application Priority Data
Jan. 9, 2007 (JP) 2007-001790

(51) Int. Cl. F16G 13/04

(52) U.S. Cl. 474/212

(57) ABSTRACT

In a link plate for a silent chain, outer flanks of the teeth have a protruding surface and a retracted surface, the protruding surfac and the retracted surface being connected by a step, and the protruding surface being farther than the retraced surface from the back of the link plate. Both the protruding surface and the retracted surface comprise straight portions, and, preferably, the protruding surface is shaved, whereas the retracted surface is not shaved.

### CROSS-REFERENCE TO RELATED APPLICATION

This application claims priority on the basis of Japanese application 2007-001790, filed Jan. 9, 2007. The disclosure of Japanese application 2007-001790 is hereby incorporated by reference.

### FIELD OF THE INVENTION

Silent chains are used to transmit rotation from a driving sprocket to one or more driven sprockets in a mechanism such as a timing drive in an internal combustion engine. This invention relates to the link plates of silent chains, and the invention relates more particularly to improvements in the design of the tooth flank surfaces of the link plates of a silent chain, whereby the outer tooth flank has a protruding surface which engages with a sprocket tooth, and a retracted surface which does not engage with the sprocket tooth.

### BACKGROUND OF THE INVENTION

A silent chain is composed of interleaved rows of link plates interconnected in articulating relationship by connecting pins. In a typical silent chain, each link plate has a pair of pin holes for receiving connecting pins, and a pair of teeth for meshing engagement with driving and driven sprockets. The shapes of the teeth of the link plate determine the manner in which the teeth of the chain engage and seat on the sprocket. One type of silent chain exhibits inner flank engagement and outer flank seating, wherein, as the chain approaches a sprocket, an inner flank of a link plate first engages a sprocket tooth, and, as the chain moves around the sprocket, the link plate becomes seated in such a way that its contact with the sprocket is contact between its outer tooth flanks and the sprocket teeth. In another type of silent chain, exhibiting outer flank engagement and outer flank seating, an outer flank first engages a sprocket tooth. As the chain wraps around the sprocket, the link plates are seated with their outer flanks in contact with the sprocket teeth as in the case of the chain exhibiting inner flank engagement and outer flank seating.

In the inner flank engagement/outer flank seating silent chain, after the inner flank of a forward tooth of a link plate first comes into contact with a sprocket tooth, the inner flank slides on the sprocket tooth surface toward the tooth gap bottom. As this sliding action occurs, engagement is shifted from the inner flank to an outer flank surface, so that the front and rear outer flanks sequentially slide along tooth surfaces of the sprocket teeth until the front and rear teeth become seated on the sprocket. Power is transmitted between the chain and the sprocket though the seated link plate teeth.

On the other hand, in the outer flank engagement/outer flank seating silent chain, an outer flank of the rear tooth of a link plate first comes into contact with a sprocket tooth at the start of engagement. The outer flank continues to contact the sprocket tooth until the completion of engagement, when the front outer flank comes into contact with a sprocket tooth. Thus, the link plate becomes seated with the front and rear flanks of its link plates engaged with sprocket teeth.

Since the silent chain has two steps of contact in the engagement between a link plate and a sprocket, the impact is small, and the generation of noise is suppressed. This invention is applicable both to a silent chain of the inner flank engagement/outer flank seating type, and a silent chain of the outer flank engagement/outer flank seating type.

It is known to provide a link plate in which an outer flank of a tooth includes a substantially straight, shaved, linear surface extending from a shoulder of the link plate to a location near the tip of the tooth. Such a link plate is described in Japanese Laid-Open Patent Publication No. Hei. 9-217796. Since tension is applied to a silent chain during power transmission, a link plate in which a portion of the outer flank is substantially linear can be subject to cracks and fracture at the location where the distance between the pin hole and the outer flank is the shortest. To avoid such cracks and fracture, a link plate has been provided, as shown in FIG. 3, in which the outer flank has a convex, curved, protruding portion in a region where the distance between a pin hole and an outer flank surface is short. Such a link plate is described in U.S. Pat. No. 6,155,945, granted Dec. 5, 2000.

When a silent chain is wound around sprockets to transmit power, the portion of the outer flank near a shoulder of the link plate does not come into contact with a sprocket tooth at all. Thus, the portions of the outer flanks near the shoulders of the link plates in Japanese Laid-Open Patent Publication No. Hei. 9-217796 and in U.S. Pat. No. 6,155,945 are not involved in engagement with the sprocket.

A link plate is generally formed from a band of steel sheet by punching, and the residual steel is reused because the steel material from which the link plates are made has become expensive. In the link plates disclosed in the above-mentioned Japanese patent publication and U.S. patent, because the outer flank surfaces near the link plate shoulders, which are not involved in engagement with a sprocket tooth, are parts of the link plate, the link plate becomes expensive, with little, if any, concomitant benefit by way of performance.

In the link plate disclosed in Japanese Laid-Open Patent Publication No. Hei. 9-217796, the outer flank surface is subjected to shaving. However, variations in shaving accuracy and variations between lots of material can cause the shaved surface to be shifted toward the pin holes of the link plate. In such a case, a step is often formed at a boundary between a shaved surface and a non-shaved surface, with the result that, when a tooth portion of a link plate seats on a sprocket tooth, abutment of the step with the sprocket tooth generates abutment noise. Furthermore, there is a problem in that, in the link plate in U.S. Pat. No. 6,155,945, since the outer flank surface near the pin hole protrudes as shown in FIG. 3, there is a step 13b. Wear of the engagement surface of the link plate increases the size of the step, and, when a tooth of the link plate seats on a sprocket tooth, the step abuts the sprocket tooth and generates noise.

This invention addresses the aforementioned problems in the prior art by providing a link plate for a silent chain, which can be formed economically, in which noises which are generated when a link plate tooth engages with a sprocket tooth can be prevented, in which only a shaved surface formed on an outer flank is allowed to come into contact with a sprocket tooth during engagement and during seating, and in which the non-shaved surface is not allowed to come into contact with the sprocket tooth.

### SUMMARY OF THE INVENTION

The link plate in accordance with the invention has a back, a pair of pin holes, and a pair of teeth. Each pin hole is adapted to receive a connecting pin for articulably connecting interleaved rows of link plates to form a chain. Each tooth of the link plate has a tip, an inner flank, and an outer flank. The outer flank extends from a shoulder adjacent the back of the link plate toward the tip of the tooth, and the outer flank comprises first and second parts connected to each other by a step. The first part is positioned farther than the second part from the back of the link plate, and protrudes relative to the second part. The first part comprises a first straight linear edge portion adapted to engage a sprocket tooth, and the second part also comprises a second straight linear edge portion. However, the second part is in a retracted position relative to the first part so that the second straight linear edge portion is prevented from coming into contact with a sprocket tooth.

Preferably, the first straight linear edge portion is a shaved surface, and the second straight linear edge portion is a non-shaved surface.

The terms “shaving” and “shaved” as used herein refer to processing for improving the shear plane coefficient and reducing roughness of an edge, such as an outer tooth flank, of a link plate by cutting a rough surface and a shear drop generated during punching of the link plate. Shaving is carried out by means of a shaving tool that extends slightly beyond the edge of the punch used to punch a blank punched from a band of sheet steel.

According to the invention, since the surface having a straight linear part for engagement with a sprocket tooth protrudes from a portion of the outer flank adjacent the tip of the tooth, and the surface having a linear, straight, portion which does not come into contact with the sprocket tooth is close to the shoulder of the link plate, and retracted relative to the shaved part, a portion of the link plate, which is not involved in engagement with a sprocket tooth, is not removed from the band of steel sheet during manufacture. Thus, a link plate can be formed economically, without needless use of steel.

Furthermore, since the protruding portion of the outer flank engages a sprocket tooth, whereas the retracted portion, positioned between the protruding portion and the shoulder of the link plate, does not come into contact with the sprocket, the shoulder of the link plate does not abut a sprocket tooth as the link plate is seating on the sprocket, and consequently, noises generated as the link plate is seating can be prevented.

When the protruding surface of the outer flank of the link plate is a shaved surface, and the retracted surface is a non-shaved surface, the non-shaved surface does not abut the sprocket tooth, but the shaved surface always comes into contact with a sprocket tooth. In this way, the engagement surface is stabilized so that engagement accuracy, fatigue strength, and desirable dynamic performance characteristics such as wear resistance, noise reduction, and the like, can be maintained.

Furthermore, since only the protruding surfaces are subjected to shaving, special measures to ensure accuracy during maintenance of the punches used to form the link plates are unnecessary. For the same reason, positioning shifts due to differences in steels used as the materials for the link plates, and position shifts due to variations in the accuracy of the punches, are less serious, and less labor is required for management of lots of raw material and for maintaining manufacturing accuracy.

### BRIEF DESCRIPTION OF THE DRAWINGS

FIG. 1 is an elevational view of a link plate according to the invention;

FIG. 2 is a schematic elevational view showing the link plate of FIG. 1 engaged with and seated on sprocket teeth; and

FIG. 3 is an elevational view of a link plate of a conventional silent chain.

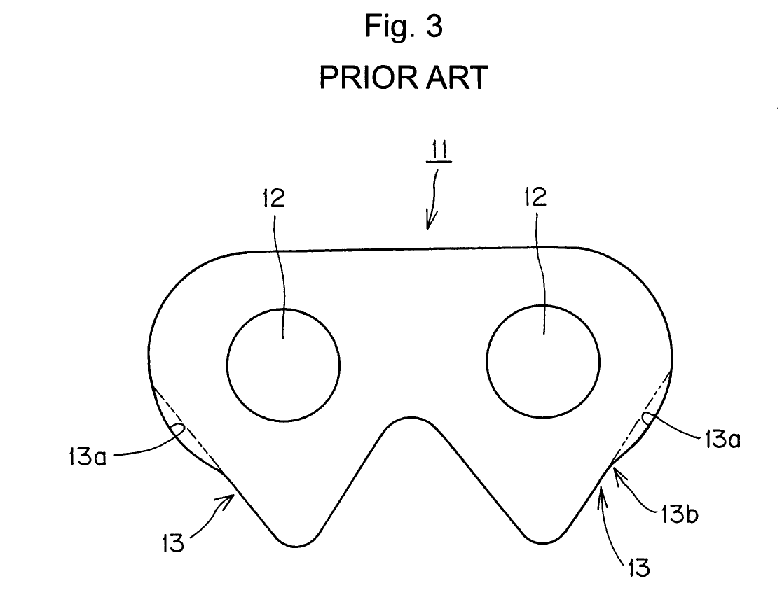

### DETAILED DESCRIPTION OF THE PREFERRED EMBODIMENT

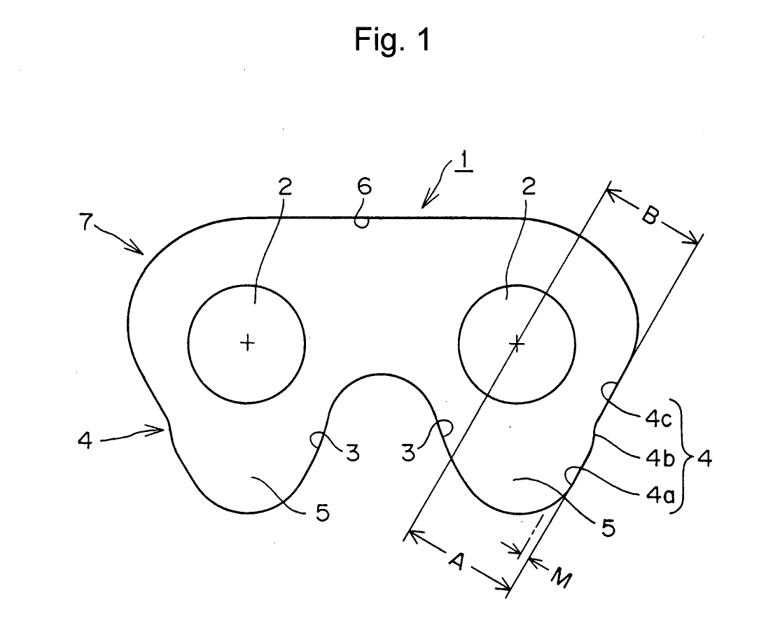

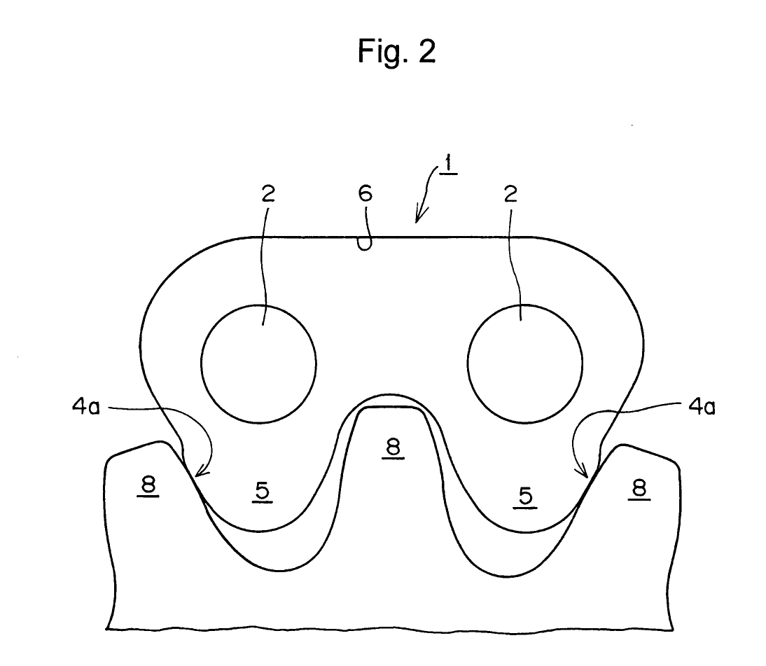

As shown in FIGS. 1 and 2, a silent chain link plate 1 according to the invention comprises a pair of pin holes 2, into which connecting pins (not shown) are inserted, a pair of teeth 5 having inner flanks 3 and outer flanks 4, a back surface 6, and a shoulder 7. The shoulder 7 is in the form of a curved surface extending from a retracted portion 4c of the outer flank 4 and the back surface 6.

The outer flank 4 is provided with a step 4b having a height M. A straight, linear protruding surface 4a, for engagement with a sprocket 8 as shown in FIG. 2, is formed on the portion of the outer flank extending from the step 4b toward the tip of the tooth. The retracted portion 4c of the outer flank is formed with a straight linear surface 4c, which does not come into contact with the sprocket tooth 8. As shown in FIG. 1, the protruding surface 4a and the retracted surface 4c are parallel to, but offset from, each other, being connected by the step 4b. If the distances between the center of the pin hole 2 and the protruding surface 4a, and between the center of the pin hole 2 and the retracted surface 4c, are defined as A and B respectively, where A>B, the height M of the step by which the two surfaces 4a and 4c. are connected is defined by M=A−B.

As in the case of a conventional silent chain link plate, the link plate according to the invention is punched in a press from a band of sheet steel. However, the shaving of the shaved portion of the outer flank is carried out in a separate step. The punched link plate before shaving has the same outer shape as that of the shaved link plate 1 shown in FIG. 1, and the outer flank surfaces have steps. Prior to shaving, the link plate also has straight, linear, retracted surfaces on the portions of its outer flanks that extend from the steps to the shoulders. These retracted surfaces do not come into contact with the sprocket teeth. After shaving the protruding, straight portions of the outer flanks, the link plates are gathered into guide rows and joint rows, and the rows are interleaved with one another and connected by connecting pins to form an endless chain.

The punching operation for forming a link plate is carried out in a sequential series of punching steps including punching the holes, punching the back surface, punching the inner flanks and punching the outer flanks. As these punching steps are carried out on a band of sheet steel, connecting parts remain so that the link plate remains connected to the steel sheet. These include-connecting parts at the shoulders of the link plate. Then, the protruding surfaces of the outer flanks are shaved by a shaving tool. After the shaving step, the connecting parts are punched from the band steel sheet, and the link plate thus formed, as shown in FIG. 1, is removed from the press. The link plates are then formed into an endless silent chain.

When the silent chain made up of link plates according to the invention is wound around sprockets to transmit power, whether in an inner flank engagement/outer flank seating silent chain, or in an outer flank engagement/outer flank seating silent chain, the shaved protruding surfaces 4a on the front and rear outer flanks 4 of the teeth 5 seat stably on the sprocket teeth as shown in FIG. 2.

In the link plate of the invention, portion of the outer flanks that are not involved in engagement with sprocket teeth are not removed from the band of sheet steel in the punching process. Thus, the link plates can be made more economically, without waste of steel, and the portions not removed in the punching process remain as part of the band of sheet steel and are reused.

In a case of a link plate link plate of the invention, even if the protruding surfaces of the outer flanks are not subjected to shaving, when the teeth of the link plate seat on the sprocket teeth to be seated no portion of the shoulder abuts the sprocket tooth. Therefore, noise generated during seating can be prevented.

In the case where the protruding surfaces of the outer flanks surfaces are shaved, and the retracted surfaces are non-shaved surfaces, even though a boundary or step exists between the shaved protruding surface which, and the non-shaved retracted surface, the non-shaved surface does not abut the sprocket tooth 8. The shaved surface, always comes into contact with a sprocket tooth, and the engagement surface is stabilized. Its dynamic performance, including engagement accuracy and fatigue strength of the teeth, is improved, and wear of the sprocket teeth, noise and the like can be maintained at low levels.

Furthermore, as mentioned previously, since only the protruding surfaces are subjected to shaving, maintenance of the punches is simplified, and less labor is required to manage lots of raw material and to maintain manufacturing accuracy.

What is claimed is:

1. A link plate for a silent chain having a back, a pair of pinholes, each pin hole being adapted to receive a connecting pin, and a pair of teeth, each tooth having a tip, an inner flank, and an outer flank, wherein each said outer flank extends from a shoulder adjacent the back of the link plate toward the tip of said tooth, and wherein said outer flank comprises first and second parts connected to each other by a step, the first part being positioned farther than the second part from said back of the link plate, the first part protruding relative to the second part and comprising a first straight linear edge portion adapted to engage a sprocket tooth, and the second part comprising a second straight linear edge portion, the second part being in a retracted position relative to the first part so that the second straight linear edge portion is prevented from coming into contact with a sprocket tooth.

2. A link plate for a silent chain according to claim 1, in which said first straight linear edge portion is a shaved surface, and said second straight linear edge portion is a non-shaved surface.
